(19) United States
(12) Patent Application Publication
(10) Pub. No.: US 2014/0109030 A1
(43) Pub. Date: Apr. 17, 2014

(54) Method of Determining Electromigration (EM) Lifetimes and Lifetime Criteria

(71) Applicant: Intermolecular, Inc., San Jose, CA (US)

(72) Inventors: Mankoo Lee, Fremont, CA (US); Tony P. Chiang, Campbell, CA (US); Dipankar Pramanik, Saratoga, CA (US)

(73) Assignee: Intermolecular, Inc., San Jose, CA (US)

(21) Appl. No.: 13/956,220

(22) Filed: Jul. 31, 2013

Related U.S. Application Data
(60) Provisional application No. 61/713,931, filed on Oct. 15, 2012.

(51) Int. Cl. G06F 17/50

(52) U.S. Cl. CPC G06F 17/5009
USPC 716/115

(57) ABSTRACT

Methods are described for performing detailed Technology Computer Aided Design (TCAD) simulations of electromigration (EM) failure in a standard test structure suitable for the simulation of integrated circuit (IC) conductive interconnects. Methods are described for performing these simulation so as to extract from the results of these simulations criteria substantially underlying the EM lifetime of interconnects, thereby permitting rapid diagnosis of potential sites of EM failure early in the IC design and fabrication process, and thereby allowing more rapid development of reliable ICs robust against EM failure. Specific results for EM failure criteria in Cu interconnects are also presented.

### CROSS REFERENCE TO RELATED APPLICATIONS

This application claims priority pursuant to 35 U.S.C. §119, §120, and/or §365 from provisional patent application Ser. No. 61/713,931 entitled “Determination of Cu-EM Lifetime Criteria Using Physically Based TCAD Simulations,” filed Oct. 15, 2012. The entire contents of the cited provisional patent application is incorporated herein by reference for all purposes.

### FIELD OF THE INVENTION

The subject matter described herein relates generally to the field of semiconductor device manufacturing, more particularly to the failure of semiconductor devices due to electromigration failure, and most particularly to improved computational methods for determining susceptibility to electromigration failure of integrated circuit interconnect structures.

### BACKGROUND

In essence, electromigration (EM) as used herein relates to the self-diffusion of metals along an interconnection (or “interconnect”) in a semiconductor device as high current density is passed through the interconnect. This metal migration can result in voids forming in some parts of the interconnect through the departure of metal atoms, and/or hillocks formed on other parts of the interconnect due to the accumulation of metal atoms. The presence of voids will increase the resistance of the interconnect, perhaps beyond the limits set by the designers for a properly functioning device, possibly resulting in device failure or degraded performance. Hillocks may be formed in a direction parallel to the plane of the semiconductor device, possibly resulting in punching through the separating dielectric and short-circuits if contact is made with an adjacent interconnect. Short-circuits can also result if a hillock develops in a vertical direction and punches through the inter-metal dielectric in that direction. Degraded device performance and/or failure is the expected result in either case.

Although several atomic-scale processes can lead to EM failures as noted above, the chief concern in practice generally relates to the development of open circuits due to void nucleation and growth, particularly under EM stress conditions with current densities, j, about 2 MA/cm² (mega-amps/sq.cm.) at temperatures in the approximate range of 250-350 deg. C.

Electromigration has been recognized as an increasingly important cause of integrated circuit (IC) failure as thinner and more narrow metal films are used as interconnects, and current densities carried by the interconnects have increased. For a typical bulk metal, resistance heating and melting of the metal can be expected at a current density around 10⁴ A/cm² (amps per square centimeter of conductor cross-section), or about 2×10⁶ A/cm² for Cu. However, typical IC interconnects can sustain current densities of the order of 10⁷ A/cm² due in large part to the good thermal contact and heat transfer between the interconnect and the IC substrate, typically silicon. At such high current densities (or “stress” or “current stress”) EM is expected to play an increasing role in device failure.

In addition to the above, the thin film interconnects in ICs may possess small grain sizes in some cases and a high ratio of interconnect surface area (or interface area) to interconnect volume. This structure generally allows for many high mobility diffusion paths, facilitating the transport of metal atoms at reasonably low temperatures. If such diffusion paths having different mobilities intersect, accumulation of atoms (hillocks) or the nucleation of voids is expected to result at the intersection. Thus, this combination of a high driving force for electromigration (that is, high current density) and the availability of a network of different high mobility diffusion paths makes the interconnect particularly susceptible to EM damage.

EM damage is exacerbated by the modern trend towards smaller interconnect width and thickness, requiring the coalescence of fewer vacancies or voids in order to cause an unacceptable rise in resistance. In addition, the modern trend in IC fabrication employs smaller separation between interconnects separated by dielectric materials typically having relatively low dielectric constant (low k) and prone to punch-through. Thus, device failure due to hillock formation becomes a more serious concern.

As one author has stated:
“The modeling of electromigration is particularly important because it helps identify the critical weak spots of an interconnection system in a short time. A typical IC layout has millions of interconnects. Analyzing the reliability problems on each of them is prohibitively time consuming. Therefore, the key interconnects which will be investigated have to be identified through electromigration modeling.” in Electromigration in ULSI Interconnections, by C. M. Tan (World Scientific Publishing Co., 2012, p. 5-6).

Computer codes for modeling EM behavior are commercially available including “Sentaurus Interconnect, Version G-2012.06, June 2012” by Synopsys, Inc. (hereinafter “SI Code”). However, in view of the (potentially) millions of interconnects in a typical IC design, full simulations with a such a code would be prohibitively time consuming. In addition, such codes typically require numerous input parameters (perhaps as many as 30) to be supplied for the particular interconnect materials, geometries and surroundings under consideration, increasing the difficulty of a full interconnect network simulation with the SI Code, rendering it impractical to perform for many ICs of practical interest.

Thus, a need exists in the art for improved methods of identification of specific interconnects and locations within a candidate IC that are particularly susceptible to EM failures and, therefore, call for more detailed study either in the laboratory or by means of a detailed simulation such as SI Code. Such early diagnosis of prospective EM problems can greatly accelerate the design and practical fabrication of reliable integrated circuits.

### SUMMARY

Accordingly, methods are described for performing detailed Technology Computer Aided Design (TCAD)simulations of electromigration (EM) failure in a standard test structure suitable for the simulation of integrated circuit (IC) conductive interconnects. The test structure described contains both vias and interconnects, is capable of simulating currents in both forward and reverse directions, and has symmetry allowing for reduced processing time in performing full TCAD simulations.

Methods are also described for performing a set of TCAD simulations and extracting therefrom those criteria that underlie EM failure lifetimes. Such criteria are much simpler and faster to implement than are the full TCAD simulations. Specific criteria are presented for Cu and Cu alloy interconnects under conditions reasonably realistic for operating ICs.

Methods are described for performing these simulations so as to extract from the results of these simulations criteria substantially underlying the EM lifetime of interconnects, thereby permitting rapid diagnosis of potential sites of EM failure early in the IC design and fabrication process, and thereby allowing more rapid development of reliable ICs robust against EM failure. Specific results for EM failure criteria in Cu interconnects are also presented.

These and other features will be understood upon consideration of the following detailed description of and the accompanying drawings.

### BRIEF DESCRIPTION OF THE DRAWINGS

To facilitate understanding, identical reference numerals have been used, where possible, to designate identical elements that are common to the figures. The drawings herein are schematic, not to scale and the relative dimensions of various elements in the drawings are not to scale.

The teachings herein can readily be understood by considering the following detailed description in conjunction with the accompanying drawings, in which:

FIG. 1 provides 2D cross sectional and 3D cross sectional, perspective views of a 2×nm node test structure used in the TCAD simulations and for the Cu-vacancy 2D contours for (a) via-depletion under a reverse current stress condition and (b) line-depletion under a forward current stress condition, with dimensions as indicated on FIG. 1.

FIG. 2 is a flowchart for determining EM lifetime criteria based on physically based TCAD (Technology Computer Aided Design) simulations. Note, Wₘᵢₙ is the minimum width of a Cu line.

FIG. 3 is a graphical depiction of the resistance ratio (R/Rₒ) vs. EM stress time for two different combinations of initial vacancy concentration (IVC) and void formation density (VFD) in a presumed copper (Cu) interconnect for 100 μm (micrometer) M2 line simulations, computed with the SI Code cited above: (a) VFD variations for a constant IVC (8.5×10²⁰ atoms/cm³) and (b) IVC variations with 0.5 to 1.5% for a constant VFD (8.5×10²² atoms/cm³), under 2 MA/cm² stress condition at 300 deg. C. Note: “e xx” and “E xx” both denote 10^{xx}, and “xx.x h” denotes the time to failure (in hours) where failure is taken to be a resistance ratio of 1.1 or larger.

FIG. 4 is a graphical depiction of Cu vacancy and void concentrations vs. EM stress time, computed with the SI Code, with variations of (a) VFD variation under the constant IVC value of 8.5×10²⁰ atoms/cm³ and (b) VFD variations under IVC of 1% VFD condition, in the typical simulation case for 100 μm Cu-M2 line under the forward stress 2 MA/cm² at 300 deg. C.

FIG. 5 is a graphical depiction of Cu vacancy concentration vs. EM stress time, computed with the SI Code, with variations of (a) Cu grain boundary surface energy density (GED) and (b) Cu surface energy density (SED) of the void for 100 μm Cu-M2 line under the forward stress 2 MA/cm² at 300 deg. C. The units of GED and SED are Jₒ(Joules)/cm².

FIG. 6 is a graphical depiction of results of an improved method of determining EM lifetime criteria: (a) length dependent EM lifetime saturated behaviors with variations of current density and (b) jL product vs. line length plot for determining EM lifetime. “Safety”, “Aware”, and “Failure” regions for EM reliability are indicated. The temperature was taken to be 300 deg. C for all cases depicted.

FIG. 7 is a graphical depiction of temperature dependencies for: (a) line resistance vs. time for different temperatures under both forward (For) and reverse (Rev) current stresses according to the geometry of FIG. 1 for 100 μm Cu-M2 line under the EM stress, that is ±2 MA/cm², and (b) Cu line length/lifetime vs. jL plot under various combinations of line length (10-70 μm, step 10 μm) and jL (2500-8000 A/cm, step 500 A/cm) in the EM aware region at a temperature of 300 deg. C.

FIG. 8 is a schematic depiction of a model for void growth formation with a cubicle-type void shape for a simplified EM failure lifetime analysis.

### DETAILED DESCRIPTION

After considering the following description, those skilled in the art will clearly realize that the present teachings can be readily used for early and rapid identification of possible electromigration (EM) failure modes and failure sites in conductive interconnects in integrated circuits (ICs), as well as techniques for determining EM lifetime criteria that can be more readily implemented for the analysis of potential EM failures than can full computer simulations.

Designing and fabricating IC interconnects that are robust against EM failure becomes a more serious challenge as line widths are substantially reduced with successive advances in IC technology. To be concrete in our descriptions, we will focus on the specific example of copper (Cu) interconnects and Cu-alloy interconnects, For economy of language we use Cu to indicate either Cu or Cu-alloy materials. This is by way of illustration and not limitation in that the methods described herein can be utilized for other interconnect materials, as would be apparent to those having ordinary skills in the art. Also, Cu interconnects have considerable practical importance in present and future ICs so these examples are likely to be among the most important cases for practical IC fabrication.

The reduced scale of Cu interconnects results in smaller grain sizes in the Cu material, increased dependency on the barrier layer(s) as well as substantial atomic migration at the Cu-capping interface. These effects (among others) complicate carrying out TCAD (Technology Computer Aided Design) simulations by, for example, requiring use of process-dependent vacancy parameters. One goal of the methods described herein is to provide methods to elucidate (and to elucidate for some examples related to Cu interconnects), the relationship(s) between the internal microstructure of Cu-alloy interconnects and physical EM failure kinetics. Obtaining this information concerning Cu-line EM lifetime criteria in rapid, early simulations would enable the improvement of the density, performance and reliability of the overall IC chip. Also, such methods may allow for the development of effective EM test structures and Cu-alloy doping elements that may further improve the EM lifetimes.

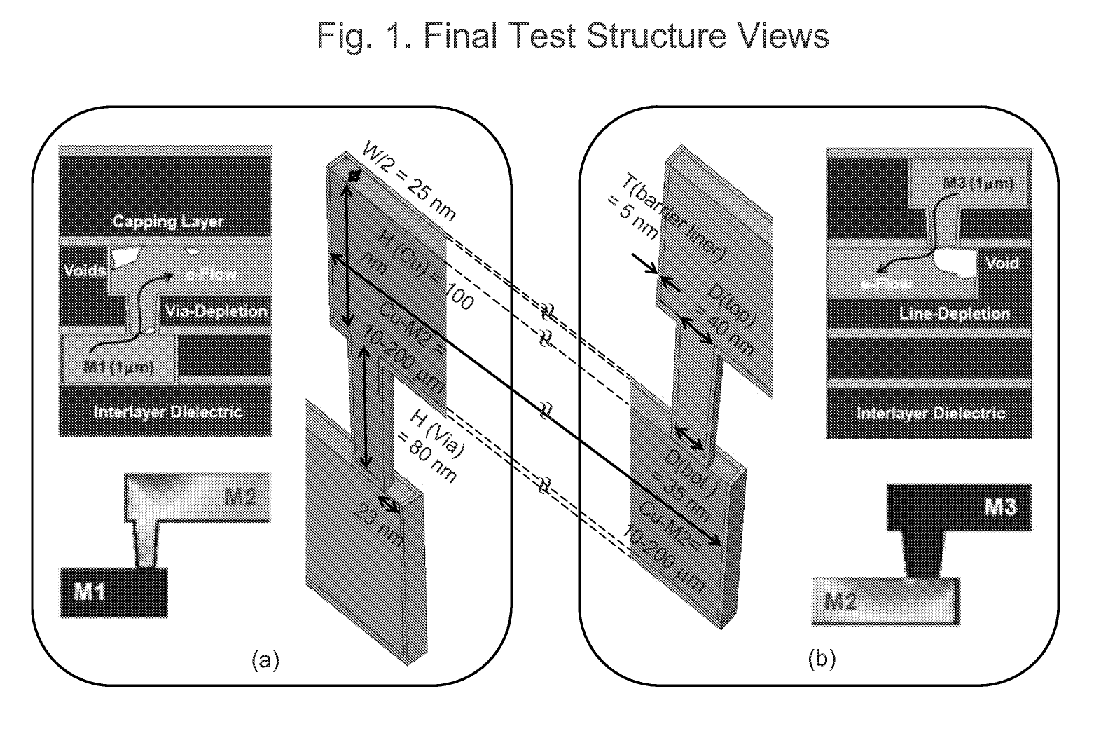

The methods reported herein to determine Cu-line EM lifetimes make use of detailed TCAD simulations performed for an assumed standard 3-dimensional (3D) EM test chip. Unless otherwise noted, the simulations reported herein were carried out with the SI Code noted above. The standard 3D EM test structure used herein is chosen to be compatible with 2×nm node BEOL technology and is depicted in FIG. 1 (where nm=nanometer=10⁻⁹ meter=0.001 μm. BEOL=Back End of Line). The test structure depicted in FIG. 1 was used to reproduce in the computer simulations both the experimentally observed change in resistance due to electromigration as well as the experimentally observed behavior in the change of resistance arising in connection with EM failures. A 3-dimensional cross-section cut at the middle of the line width was conveniently used to reduce the mesh size used in the TCAD simulations. The simulated test layout that was used for 2×nm nodes was a 50 nm wide 2nd-level metal Cu-line (designated M2 in FIG. 1) with a 1.7 aspect ratio, encapsulated with a 5 nm thick TaN (tantalum nitride) barrier layer and connected to electrodes M1 and M3. This non-symmetrical structure includes the M2 Cu-via with a diameter approximately 40 nm at the anode side.

This structure of FIG. 1 allows for the simulation of electron flow dependencies (line-depletion versus via-depletion), and is typically used for a 2×nm node dual-damascene structure. See, for example, “Low-K Interconnect Stack With Metal-Insulator Capacitors For 22 nm High Volume Manufacturing,” by D. Ingerly et al, Proc. IEEE IITC, June 2012, the entire contents of which is incorporated herein by reference for all purposes. As depicted in FIG. 1, both forward and reverse current density EM stresses can be simulated with this single test structure by simply exchanging the cathode and anode structures in the simulation. This leads to different EM results between line-depletion (FIG. 1b) and via-depletion (FIG. 1a).

In addition to the ability to test EM stresses in both forward and reverse directions, the test structure of FIG. 1 has 23 nm marginal M2 Cu-line extension from the ends of the via. This can improve EM lifetime, having an effect as a reservoir of Cu-vacancies (Cᵥ). As depicted in FIG. 1, barrier liners, such as TaN (tantalum nitride), are connected together through M1 to M3 to continuously observe the resistance slope (Rₛₗₒₚₑ) of the M2-Cu line after EM failure. Barrier layers including ruthenium (Ru) or cobalt (Co) can also be employed.

The simulations are based on the EM full void growth model and include vacancy super-saturation in the Gibbs free energy (ΔG) calculation based on Rosenberg's void growth theory. (“Void Formation and Growth During Electromigration in Thin Films,” by R. Rosenberg and M. Ohring, J. Ap. Phys. Vol. 42, No. 13, pp. 5671, December 1971, the entire contents of which is incorporated herein by reference for all purposes.) A Cu-vacancy agglomeration induced under EM stress typically lowers ΔG to nucleate voids as depicted in FIG. 1. Lowering ΔG for void formation by increasing Cᵥ starts to create tensile stress. Then, void nucleation and growth continuously occur until the current flow through the Cu metal ceases. Eventually, following EM failure, void growth expands continuously until the force tending to grow the voids by tensile stress is balanced by forces tending to shrink the voids by surface tension. Therefore, the vacancy concentration in equilibrium with the voids depends on the surface tension of the metal.

We use herein the following values for Cu-line EM parameters which are believed to typical:
VFD (void formation density)=8.5×10²² atoms/cm³.
IVC (initial vacancy concentration)=1% VFD.
SED (surface energy density) of the C_{void} (Cu-void) interior=1.7×10⁻⁴ Joules (Jₒ) /cm².
   where c_{void}=concentration of Cu voids.
GED (grain-boundary surface energy density of voids)=6.3×10⁻⁵ Jₒ/cm².
CON (electrical conductivity of Cu-line=4.0×10⁵ Ω⁻¹cm⁻¹=4.0×10⁵/(ohm-cm).
Effective Charge Number of Cᵥ=64 (as used in SI Code) for Cu-M2 line length (L)=100 μm under forward EM stress with j (current density)=2 MA/cm² at 300 deg. C. (MA=mega amps).

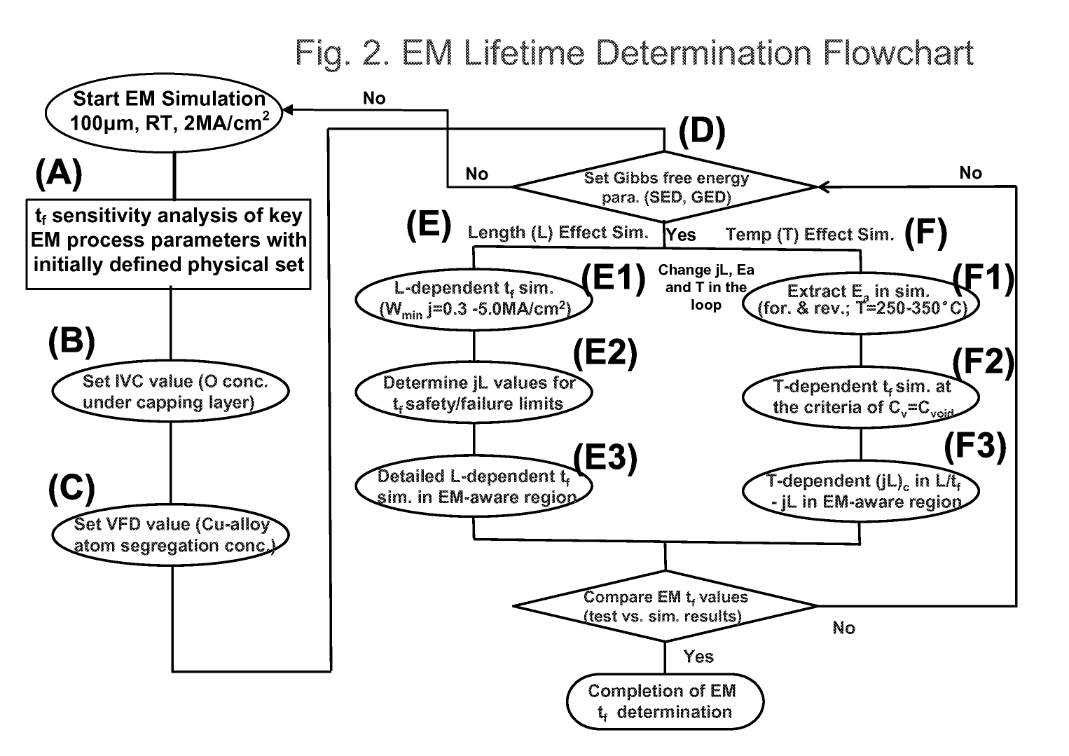

FIG. 2 depicts some embodiments of the methods described herein in flowchart form. The method begins with the sensitivity analysis of the EM failure time t_{f} for EM process parameters including VFD, IVC, SED, GED, CON depicted in the upper left block of FIG. 2.

A sensitivity analysis for t_{f} is carried out with the SI Code for the listed parameters as depicted in Block A. In Blocks B and C, IVC and VFD values are set based upon the initially used oxygen impurity content (or concentration) and the segregation concentration of Cu-alloy atoms respectively for the given Cu-alloy under consideration, typically Cu-aluminum (CuAl) or Cu-manganese (CuMn) alloy.

Block D sets the Gibbs free energy parameter values for SED and GED. Some embodiments of the methods discussed herein use these two parameters as the chief “tuning parameters,” correlated with the degree of Cᵥ agglomeration near M1-M2 via (for the reverse current case, FIG. 1a) and near the cathode (case of forward current, FIG. 1b). The Gibbs free energy Block D is followed by two distinct simulation loops for the length effects on t_{f} (Loop E) and the temperature effects of t_{f} (Loop F).

The IVC includes a sum of all initial vacancies that can be affected by the Cu-alloy scheme with dopants using PVD (physical vapor deposition) seeds, including manganese (Mn), aluminum (Al), cobalt (Co), magnesium (Mg), tin (Sn), zirconium (Zr), gold (Au), silver (Ag), palladium (Pd), iron (Fe), beryllium (Be), among others, as well as follow-up annealing conditions (NH₃, N₂/H₂, among others), in the temperature range from approximately 150 deg. C to approximately 350 deg. C. Components of the IVC may be located at Cu grain interiors, Cu grain boundaries and the interfacial interface underneath capping layer materials (CoWP, CoSnP, CoWB, SiCN, SiN, among others). Another portion of IVC can be related to the oxygen contamination under the capping layer. A source of oxygen (O) and TaN oxidation can be the Co-carbonyl precursor used in the CVD (chemical vapor deposition) process. Therefore, it seems prudent to include possible O-related vacancies in IVC until an oxygen-free process is available for process calibration.

For the particular case of CuAl alloy, Al segregated near the capping layer can react with oxygen to form Al₂O₃ that can increase initial vacancy concentration, IVC.

For the case of CuMn alloy, Mn atom segregation enhances EM lifetime continuously with Mn alloy concentrations from 0% to about 4%, apparently independent of oxygen at the SiCN/Cu interface. This suggests that Mn segregation is driven by something other then oxygen as noted in “Electromigration Extendibility of Cu(Mn) Alloy-Seed Interconnects and Understanding the Fundamentals,” Proc. of IEEE IEDM, December 2012, the entire contents of which is incorporated herein by reference for all purposes. This implies an increase in the segregated metallic Mn preferentially at the capping layer interface.

IVC may also be affected by smaller grain size underneath the capping layer (for example, SiCN), at least (⅓) to (¼) the grain size of the Cu bulk. These effects can be worse for narrower line widths due to possible strain stress during barrier line formation.

Since IVC values may underlie the effects of alloy doping and oxygen contamination, IVC is thus likely to be one of the important process parameters, accordingly calling for calibration with full TCAD simulations.

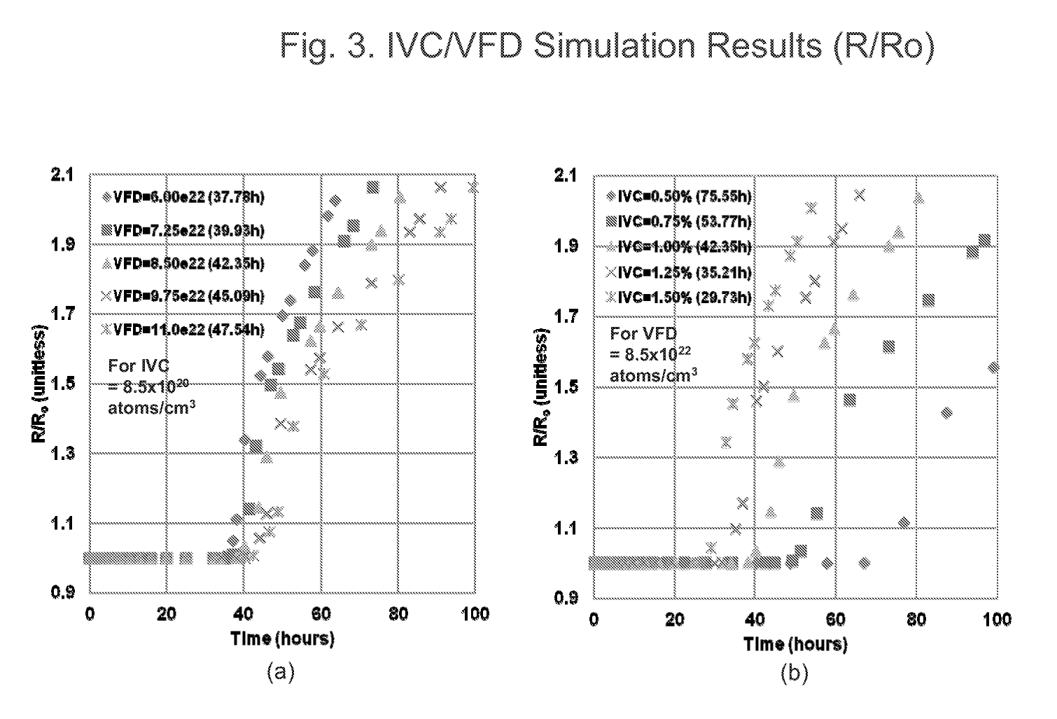

Since IVC is closely related to back-end of line (BEOL) process conditions, IVC might be calibrated for each particular process of interest. FIG. 3(a) shows the resistance ratio (R/Rₒ) vs. EM stress times to failure for various VFD values for a typical IVC value. FIG. 3(b) shows the resistance ratio vs. EM stress time to failure for various IVC values of 0.5% to 1.5% for VFD of 8.5×10²² atoms/cm². A smaller IVC is seen generally to give rise to a longer t_{f} with a more gradual Rₛₗₒₚₑ after the onset of EM failure in simulations. For the data of FIG. 3, a resistance ratio of about 1.1 is taken to be failure The composite simulations for both IVC and VFD changes are adjustable (tunable) as process parameters. This predicts the importance in Cu formation processes of reducing or minimizing the initial Cᵥ value to achieve a longer t_{f}, which may be related to grain size, oxygen content, and Cu-alloy materials in 2×nm nodes.

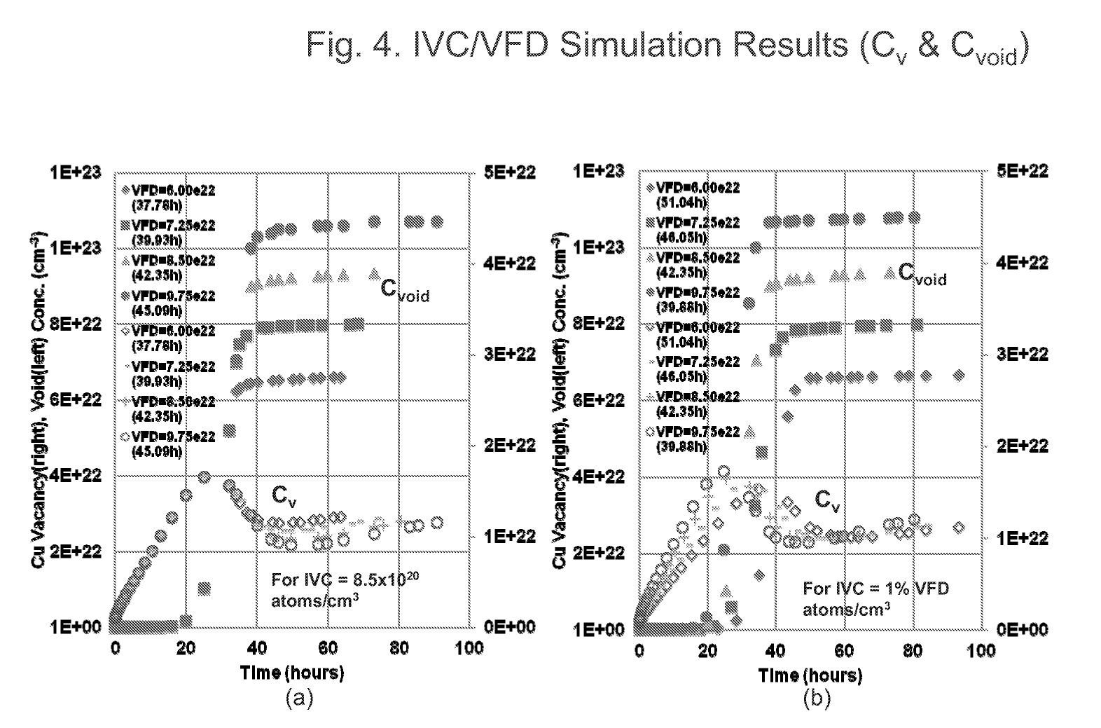

FIG. 4 shows the influence of changes in VFD and IVC values on the profile variations of Cᵥ (right axis) and C_{void} (left axis). When C_{void} reaches the specified VFD level, we may define EM lifetime failure criterion as a change of about 10% in the line resistance (ΔR/Rₒ) as computed in the simulations. FIG. 4(a) shows no significant influence on Cᵥ profiles by the change in VFD level until it reaches a peak value. In contrast, when both IVC and VFD values are varied in the same percentage range (−18% to 18% for 3 sigma values), the profiles of Cᵥ and C_{void} change accordingly as shown in FIG. 4(b). FIG. 4 also demonstrates that IVC more sensitively affects t_{f} than does VFD but with an opposite trend. It should be noted that a higher line conductivity results in a longer t_{f} by creating less Cᵥ and C_{void} for given VFD and IVC conditions. This also lowers the current density exponent (n) of Black's equation under the given EM conditions. For a discussion of Black's equation including the exponential parameter n, see “Electromigration in ULSI Interconnections,” by C. M. Tan (World Scientific Publishing Co., 2012, pp. 22-29, particularly Eq. 2.24 on p. 23, the entire contents of which is incorporated herein by reference for all purposes).

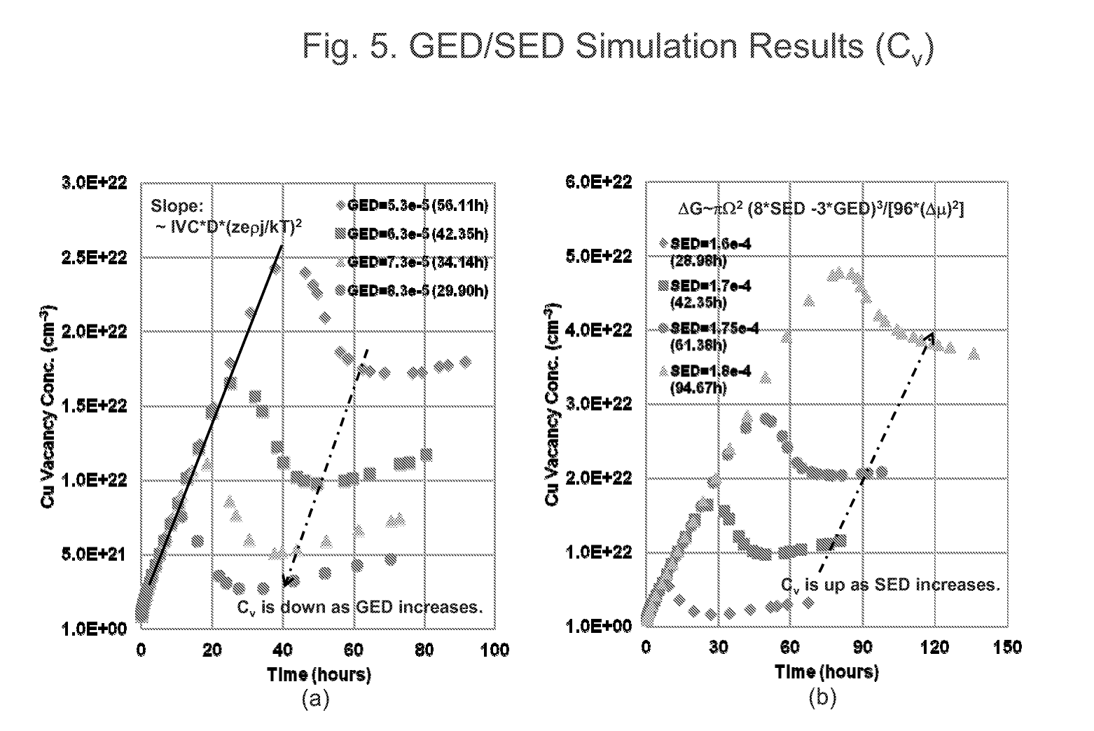

Vacancy transport takes place predominantly at the Cu-void surface and at grain boundaries as injected electrons have a wind-like effect, leading to Cu atom migration during a high current density EM stress. Thus, transport kinetics can be determined by the two major SED and GED parameters, although the current density (j) is the dominant stress factor for Cᵥ as an initial EM condition. FIG. 5 shows the sensitivity of Cu-vacancy concentrations in terms of current density, GED, and SED under typical simulation conditions. Since Gibbs free energy of a void formation increases by SED but decreases by GED, it is feasible to predict their sensitivities to Cᵥ changes and C_{void} reasonably well as shown in FIG. 5. It is noted that SED is a more sensitive parameter than GED for Cᵥ variation in simulations. Since these are theoretical parameters and difficult to measure, it is advantageous to use them as tuning parameters, effectively listed as a condition step in the flowchart, FIG. 2.

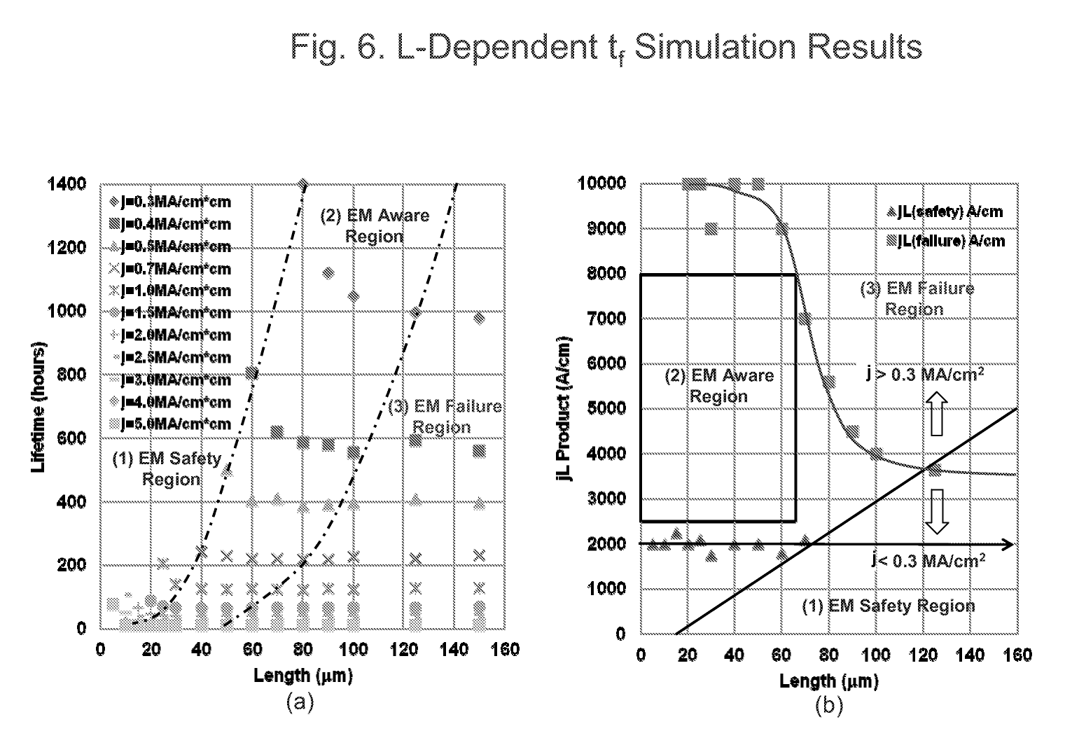

Cu-line EM lifetime was simulated for a range of interconnect lengths and current densities (branch E of FIG. 2), and it was confirmed that the simulated results match the trend of the previous EM tests. For a given j value, the lifetime decreases with increased length and tends to saturate beyond a certain value of length L. From the various j and L conditions, we simulated length dependent t_{f} for 11 different j values under typical simulation conditions as shown in FIG. 6(a). The critical line length at the given j value that leads a t_{f} saturation was found. As a result, one could expect the saturated lifetime to correspond to the worst (or failure) condition. However, the level of detail provided by the simulations allows a more nuanced approach to determining failure criteria. Two asymptotical parabolic lines have been derived that define 3 figure-of-merit regions for determining EM lifetime in terms of the product of current density and length, jL (in A/cm): a region of “safety” from EM failure, a region in which one needs to be alert to the possibility of EM failure, that is an “aware” region, and a region of EM “failure”. These regions and lines are depicted in FIG. 6a.

When a new or different BEOL interconnect technology is introduced or under consideration (e.g., 22 nm node), one can use physically based TCAD simulation to define these 3 different EM regions for the technology node; Safety, Aware and Failure. Based on the jL product, EM safety and failure boundaries can be specified. In this particular case, jL less than about 2000 A/cm corresponds to the safety region and jL greater than about 9000 A/cm to the failure region, as shown in FIG. 6(b). The EM safety boundary (jL approximately 2000 A/cm) is almost constant up to about 70 82 m Cu-line length. (μm=micrometer=1000 nm=0.0001 cm). The failure condition (jL about 9000 A/cm) shows a nonlinear behavior, with the boundary line sharply falling in the range of 60-125 μm. Thus, the EM-aware region can be set in the range of about 2500-8000 A/cm.

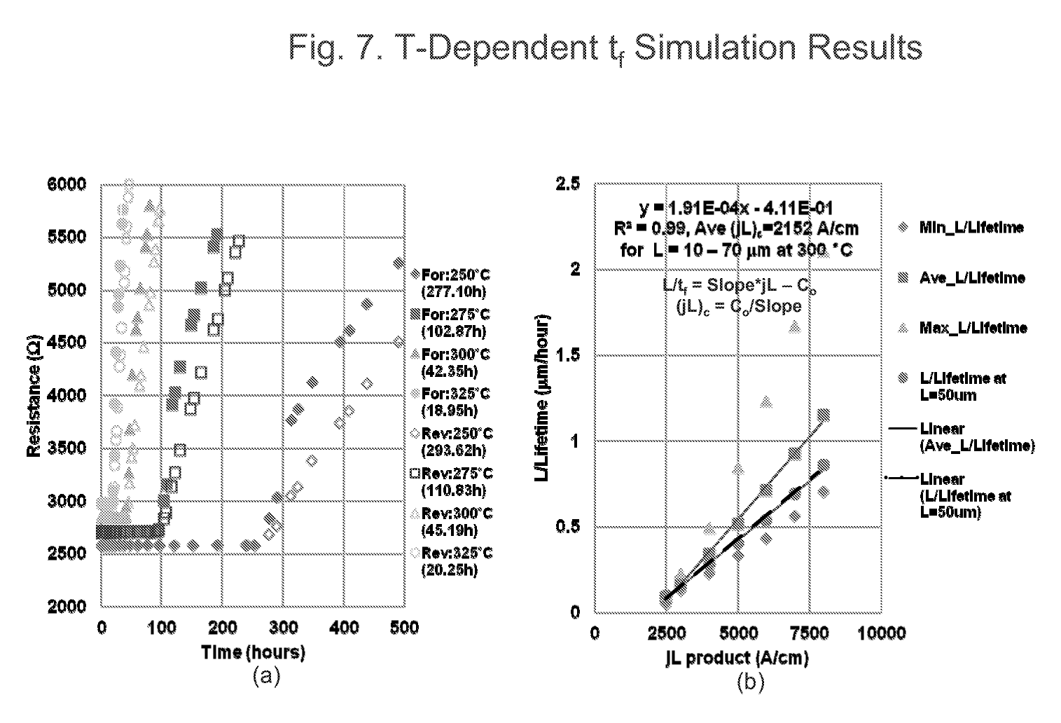

On the F branch in FIG. 2 evaluating the effect of temperature T, three steps are typically performed. First, activation energies associated with the diffusion process, Eₐ, are extracted from an Arrhenius plot of failure times with initial value of Cu-vacancy diffusivity of 0.9 eV (using a 10% resistance increase as the failure criterion) under the stresses of forward and reverse current directions. It is also confirmed that the EM stress of the reverse electron flow results in a slightly longer t_{f} than that of the forward electron flow, possibly due to increased Cu thickness from the M1 to M2 via at the anode side in the Cu-line. As a result, resistance differences between line and via depletion cases were noted after EM failure as depicted in FIG. 7(a). For a 100 μm line under typical simulation conditions, varying only the line temperature (200-375 deg. C in steps of 25 deg. C), Eₐ values of 0.97 and 0.96 eV (electron Volts), were extracted for the forward and reverse current density directions, respectively. These values are within about 10% variation of the initial Eₐ value. In addition, both slow and fast void growth rates can be observed, depending on temperature, prior to reaching t_{f}. Also one can define t_{f} at the time when C_{void} has reached the same value of Cᵥ under EM stress at the different temperatures to confirm temperature dependency on t_{f}. Furthermore, to extract a temperature effect on the Blech Threshold (jL)_{c}, we used various j and L stress conditions in the EM aware region previously defined, based on the L/t_{f} versus jL plot as described in “Electromigration Threshold in Copper Interconnects” by C. Wang and R. G. Fillippi, Ap. Phys. Lett., vol. 78, no 23, pp. 3598-3600 (2001), the entire contents of which is incorporated herein by reference for all purposes. For a discussion of the “Blech Effect” or the “Blech Length Effect” see “Electromigration in ULSI Interconnections,” by C. M. Tan (World Scientific Publishing Co., 2012, pp. 23, 29, 45, 58 as well as references cited therein, the entire contents of which are incorporated herein by reference for all purposes. Note that we replace the incubation time t_{inc} by t_{f} in the plot. FIG. 7(b) shows Cu-line L/t_{f} versus jL plot under various combinations of L (10-70 μm) and jL (2500-8000 A/cm, in steps of 500 A/cm) in the EM aware region at 300 deg. C. The slope of the plot shows strong temperature and Cu-line length dependencies, such that a shorter line and a higher temperature result in a higher slope. This figure also includes the extrapolated lines for a constant 50 μm long They are slightly dependent on the temperature with a negative coefficient of about −3.1 A/(cm*(deg. C)). This slight (jL)_{c} temperature dependence is often negligible in determining the limits of j and L for EM stress conditions in the temperature range of interest.

Therefore, this proposed methodology can provide a fast and practical prediction of EM lifetime criteria by the following sequential steps: sensitivity analysis of key EM parameter correlation, determination of saturated lifetime length to define EM-aware region, and extractions of temperature dependent Eₐ and (jL)_{c}. By using the method, we are able to fully calibrate manufacturing data based on new BEOL Cu-alloy fabrication as well as production-level test information from OEM and/or foundry.

It would be advantageous to have a relatively simple and rapid method for computing reasonably correct EM lifetimes and the approximate “Safe,” “Aware” and “Failure” regions. A simplified 1-dimensional (1D) analysis of EM reliability physics is presented here as a first step in motivating such an approach. This avoids the full complexity of a numerical approach to 3D EM physics based on Cᵥ continuity equations and the relationship of Cᵥ and C_{void} that are used in the TCAD tool simulations. As such, it allows much more rapid simulations, and thus many more simulations, facilitating a more thorough evaluation of the parameter space encountered in practical fabrication of ICs with reduced susceptibility to EM failures.

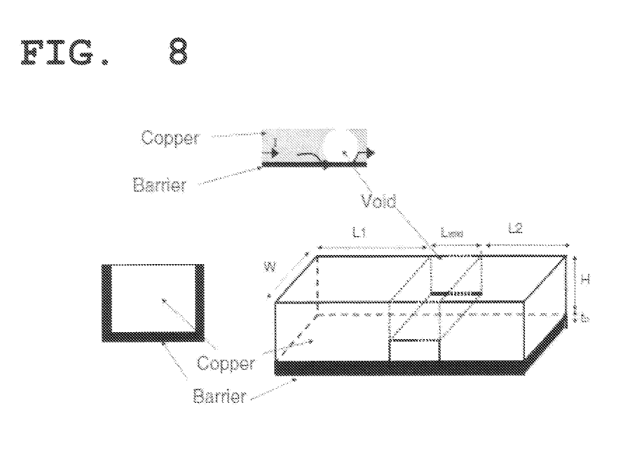

(1) Referring to FIG. 8, in 1D, the length of a void (Lᵥ) can be estimated as v_{d}*t_{f}, where v_{d} is the Cu drift velocity and t_{f} can be taken as the mean to time failure (MTTF). Rearranging this expression yields to t_{f}=Lᵥ/ν_{d}.

(2) Considering the hypothesis of a rectangular void shape from the top capping layer to the bottom liner layer, Rₛₜₑₚ can be proportional to Lᵥ from Rₛₜₑₚ=ρₛ*Lᵥ/Wₛ, where Wₛ is the possible conduction cross section and ρₛ is the combined resistivity of Cu and barrier and Rₛₜₑₚ is the step resistance between the barrier layer and the Cu line. These approximations can be applied to derive the present model for ρₛ/Wₛ given below.

(3) As the current passes through the wire, the length of the void space gradually increases until it reaches a critical value, Lᵥ, at which the atoms of copper in this region are depleted. Rearranging the expression in paragraph (2) above yields Lᵥ=Rₛₜₑₚ*Wₛ/ρₛ. We thus obtain ρₛ/Wₛ=[(ρ_{b}/(t_{b}*W+t_{b}*2H))−(ρ_{Cu}/H*W)].

(4) The Cu drift velocity ν_{d} is the product of mobility (μ) and electric field (E), where μ is eZDᵥ/kT using the Einstein relationship as given in standard texts and also in the SI Code cited above. E can be expressed as ρj. Note that Z is the elementary charge of Cu, j is the current density, Dᵥ is the vacancy diffusivity. These expressions yield: ν_{d}=μ*E=(eZDᵥ/kT)*(ρj).

(5) The Cu drift velocity ν_{d} can be expressed in terms of the EM vacancy flux (Jᵥ) of −ν_{d}*Cᵥ assuming no temperature stress gradients and no hydrostatic stress gradients are present, where Cᵥ is a uniform vacancy concentration. Thus, ν_{d} can be expressed as follows: ν_{d}=−Jᵥ/Cᵥ=(eZDᵥ/kT)*(ν_{Cu}j). Dᵥ can conveniently taken to be the average diffusivity (Dₒ exp(−Eₐ/kT)).

Finally, we have the desired expression for t_{f:} t_{f}=(kT*Rₛₜₑₚ*Wₛ/ρₛ)/(eZDₒ*ρ_{Cu}*j) which is proportional to Wₛ j⁻ⁿexp(Eₐ/kT). As noted above in [0042], n is the current density exponent as also appearing in Black's Equation. We have n=−1 for a Cu-line and the EM life time is exponentially proportional to Eₐ.

Although various embodiments which incorporate the teachings of the subject matter described herein have been shown and described in detail herein, those skilled in the art can readily devise many other varied embodiments that still incorporate these teachings.

What is claimed is:

1. A method for improving the design of integrated circuits (ICs) by improving resistance to electromigration failure, the method comprising:
for a candidate IC design, varying current density j and interconnect length L through a range of values for each interconnect and, at each set of values, determining a lifetime until electromigration failure with a Technology Computer Aided Design (TCAD) computer simulation; and,
constructing one or more charts of lifetime as functions of j and L; and,
extracting from these one or more charts, one or more regions of safety from electromigration failure, one or more electromigration failure regions, and one or more aware regions of neither safety nor failure; and,
correlating the safety, failure, and aware regions with ranges of the product jL; and,
determining susceptibility to electromigration failure for interconnects within the integrated circuit by computing the product jL for each interconnect and determining if it falls in a safe, failure, or aware region, and
redesigning the IC for those interconnects in the failure region so as to move the jL product out of the failure region.

2. A method as in claim 1 wherein the TCAD computer simulation is performed on a test structure including both vias and interconnects.

3. A method as in claim 2 wherein the TCAD computer simulation is performed on a test structure capable of simulating both forward and reverse current flows.

4. A method as in claim 1 wherein the TCAD computer simulation is performed on a test structure compatible with 2×nm Back End Of Line technology.

5. A method as in claim 3 wherein the test structure has one or more marginal conductor line extensions from the end of at least one via, simulating thereby at least one reservoir for vacancies.

6. A method as in claim 3 wherein the test structure includes one or more barrier liners connected so as to permit measurement of the resistance slope following electromigration failure.

7. A method as in claim 6 wherein the one or more barrier layers contain Ta, Ru and/or Co.

8. A method as in claim 7 wherein the one or more barrier layers include TaN.

9. A method for the determination of electromigration performance of Cu interconnect sites within an integrated circuit, the method comprising:
computing the product of current density, j, and interconnect length, L, for the interconnects within the integrated circuit; and,
identifying interconnects prone to electromigration failure as those interconnects for which the jL product is greater than about 9,000 amps/cm.

10. A method as in claim 9 further comprising: identifying interconnects safe from electromigration failure as those interconnects for which the jL product is less than about 2,000 amps/cm.

11. A method for improving the design of an integrated circuit (IC) by improving the electromigration failure lifetime (t_{f}) wherein the IC contains at least one interconnect and barrier layer, the method comprising:
a) performing a sensitivity analyses on t_{f} with a sequence of Technology Computer Aided Design (TCAD) computer simulations for material properties of the interconnect and barrier layer, thereby determining the sensitivity of t_{f} to the material properties wherein the sensitivity analysis comprises:
a-1) choosing a value for initial vacancy concentration (IVC) as the estimated value of the oxygen concentration directly beneath the barrier layer; and,
a-2) choosing a value for void formation density (VFD) as the estimated value of the metal segregation concentration; and,
a-4) performing a TCAD sensitivity analysis on t_{f} to determine the sensitivity of t_{f} to IVC, VFD; and,
b) setting Gibbs free energy parameter values for the surface energy density (SED) and grain boundary surface energy density of voids (GED); and,
c) determining with TCAD computer simulation the dependence of t_{f} on the length L of a particular interconnect under consideration, and determining the range of material properties relatively safe from electromigration failure, by the following steps (c-1)-(c-4):
c-1) determining t_{f} for a sequence of L values and for a sequence of current densities (j); and,
c-2) determining safe and failure regions from the results of (c-1) and an aware region between the safe region and the failure region; and,
c-3) determining values of the jL product at the boundaries of the safe and failure regions; and,
c-4) performing further TCAD computer simulations in the t_{f} aware region; and,
d) determining the dependence of t_{f} on temperature (T) to determine safe temperature regions by the following steps (d-1)-(d-3):
d-1) determining activation energies associated with the diffusion process from an Arrhenius plot of t_{f} under forward and reverse current flows; and,
d-2) determining the temperature dependence of t_{f} under the condition that the void concentration (C_{void}) is substantially the same as the vacancy concentration (Cᵥ); and,
d-3) determining the temperature dependence of the Blech threshold (jL)_{c} in the aware region; and,
e) comparing the t_{f} values determined herein with measured values of t_{f}; and,
f) returning to step (b) if the value t_{f} values determined herein differ from the measured t_{f} values by more than a desired amount, otherwise terminate the method and record the material property values that produced adequate agreement; and,
g) employing the material properties producing good agreement between computed t_{f} and measured t_{f}, identifying interconnects susceptible to electromigration failure; and,
h) redesigning the IC so as to increase t_{f} for those interconnects susceptible to electromigration failure, thereby increasing the robustness of the IC.

12. A method as in claim 11 wherein the following parameters are used to simulate Cu interconnects:
VFD=8.5×10²² atoms/cm³,
IVC=1% VFD,
SED=1.7×10⁻⁴ Joules (Jₒ)/cm², and
GED=6.3×10⁻⁵ Jₒ/cm².

13. A method as in claim 11 wherein the at least one interconnect includes a Cu alloy interconnect.

14. A method as in claim 11 wherein the IVC includes a sum of all initial vacancies that can arise in a Cu-alloy with dopants.

15. A method as in claim 14 wherein the IVC includes a sum of all initial vacancies that can arise in a Cu-alloy from chemical processes involving oxygen.

16. A method as in claim 13 wherein the at least one Cu alloy interconnect is Cu-aluminum (Cu—Al) and/or Cu-manganese (Cu—Mn).

17. A method as in claim 16 wherein, when Cu—Al is present, IVC is adjusted to account for reactions of Al with oxygen to form Al₂O₃, thereby increasing IVC.

18. A method as in claim 11 wherein a full TCAD simulation is performed for IVC for each Back End Of Line process condition under consideration.

19. A method as in claim 11 wherein the activation energy associated with Cu diffusion extracted from an Arrhenius plot is about 0.9 eV.

20. A method as in claim 11 wherein t_{f} is determined by the time until an increase in resistance of about 10% occurs.
